(19) United States
(12) Patent Application Publication
(10) Pub. No.: US 2006/0236328 A1
(43) Pub. Date: Oct. 19, 2006

(54) Integrated graphical user interface server for use with multiple client applications

(75) Inventor: David R. DeWitt, Livermore, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/009,502

(22) Filed: Dec. 10, 2004

(51) Int. Cl. G06F 9/44

(52) U.S. Cl. 719/329

(57) ABSTRACT

The graphical user interface or associated components for two or more different applications are integrated to provide a unified graphical user interface. Applications for different purposes or from different sources are run on a same processor, system or network. Programming calls are used to generate a common graphical user interface. Information from each of the different applications is used to generate the unified graphical user interface. For example, graphical buttons, text box, pull down menus, images, dialogues, data display boxes, selection indicators, menus or other user interface components for display on a screen from different applications are combined in a same window, dialogue box or other common graphical user interface.

### BACKGROUND

Present invention relates to graphical user interfaces. In particular, graphical user interfaces for different applications are presented to the user.

Programs typically provide their own built-in graphical user interfaces. Direct programming calls within the program are used to generate the graphical user interface. For example, three or four dimensional rendering applications for medical diagnostic imaging generate their own displays. The imaging systems used for acquiring data similarly generate an independent graphical user interface. As another example, Microsoft Outlook generates a graphical user interface associated with e-mails. Microsoft Word generates a graphical user interface for the entry of text data. While both Word and Outlook use the operating system, such as Windows, for generating the graphical user interface, different graphical user interfaces are provided for each application. Different menu structures, different looks and feel and/or different layout or formats are provided for each of the separate applications.

In another approach for generating graphical user interfaces, an application specifies the graphical user interface as a hypertext mark-up language (HTML) document or page. The actual presentation of the graphical user interface for the application is rendered by a browser as a webpage. For different applications, different HTML documents or associated pages or windows are rendered. The browser or processor may present content from more than one client application, but the content of each application is generated as a separate page rendered and controlled as a whole through HTML.

Providing separate graphical user interfaces for different applications allows for easy distinction between the different applications. For example, a user may easily identify an application associated with one source, such as one provider, from an application identified with another source, such as a different provider. Similarly, a user may easily identify an application associated with one type of process, such as e-mail or three dimensional rendering, from a different application and associated process, such as word processing or diagnostic image acquisition. The different applications may be programmed to share information, such as porting acquired image data from a medical imaging application to the application for rendering three dimensional images. However, the graphical user interfaces are maintained separately. However, the user is forced to switch between different graphical user interfaces, making control more burdensome or knowledge based. Alternatively, a single graphical user interface may be provided for multiple processing, where a single application is programmed to perform the multiple processes.

### BRIEF SUMMARY

By way of introduction, the preferred embodiments described below include methods and systems for coordinating graphics and/or user input. The graphical user interface or associated components for two or more different applications are integrated to provide a unified graphical user interface. Applications for different purposes, from different sources, or programs that are otherwise separate but share output and/or input devices are run on a same processor, system or network. Programming calls or other graphical user interface related information or commands are used to generate a common graphical user interface. Information from each of the different applications is used to generate the unified graphical user interface. For example, graphical buttons, text box, pull down menus, images, dialogues, data display boxes, selection indicators, menus or other user interface components for display on a screen from different applications are combined in a same window, stored or generated XML documents that contain instructions for building the integrated graphical user interface, dialogue box or other common graphical user interface.

In a first aspect, a method is provided for coordinating graphics and/or input. First and second applications corresponding to first and second user interface data, respectively, are run. The first and second user interface data are communicated between a server and the first and second applications. The first and second user interface data is integrated in a unified graphical user interface.

In a second aspect, a system is provided for coordinating graphics and/or input. A first application is operable to generate first user interface data. A second application is operable to generate second user interface data. A server is operable to receive the first and second interface data and operable to integrate the data in a unified graphical user interface, at least partly, displayed on a graphical display device.

In a third aspect, a method is provided for coordinating graphics and/or input in a medical diagnostic imaging system. Two applications associated with two user interface data sets are run. One of the applications is a medical diagnostic imaging application. The user interface data from the two applications is communicated to a graphical user interface application and for integrating into a unified graphical user interface.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for coordinating graphics and/or input;

FIG. 2 is a block diagram of another embodiment of a system for providing an integrated graphics user input;

FIG. 3 is a flow chart diagram of one embodiment of a method for coordinating graphics and/or input; and

FIG. 4 is a graphical representation of one embodiment of a unified graphical user interface.

### DETAILED DESCRIPTION OF THE DRAWINGS AND PRESENTLY PREFERRED EMBODIMENTS

A server or application integrates the graphical user interfaces for multiple applications. The server supports inter-process communication mechanisms used by the applications to specify graphical user interface content, layout, data and event response behavior. As the client applications update the graphical user interface content, the server integrates the updates into the unified graphical user interface. Event notifications through interactions with the unified graphical user interface are routed in real time or as needed by the server to the appropriate applications.

FIG. 1 shows one embodiment of a system 10 for coordinating graphics and/or input. The system 10 includes a server 12, a display 14 and an input device 16. Additional, different or fewer components may be provided. For example, the server 12 is part of a network, such as a local area or wide area network. Any of the various processors on the network may operate individually or in conjunction with other processors to act as the server 12. As another example, multiple displays 14 are provided. Additional input devices 16 may also be provided. The display 14, input device 16 and server 12 are all located adjacent to each other, such as within a same medical diagnostic imaging system. Alternatively, one or more of the components are spaced from the other components. The system 10 is a medical diagnostic imaging system, such as a medical diagnostic ultrasound imaging system, a work station, a personal computer, a network, an embedded system, such as a system with a processor or processors dedicated to general functions like as imaging, or another now known or later developed system.

The server 12 is a processor, general processor, applications specific integrated circuit, digital signal processor, field programmable gate array, multiple processors, analog circuit, digital circuit, network server, combinations thereof, or other now known or later developed device for serving or running an application. In one embodiment, the server 12 is a processor operable to run an operating system, HTML browser, or other hardware or software for generating a display and interacting with user input 16.

In one embodiment, the server 12 is also operable to run a plurality of applications associated with different processes or a same process. For example, the server 12 is a processor or processors in an embedded system, such as a medical diagnostic ultrasound imaging system. One or more of the processors are operable to run multiple applications.

The display 14 is a CRT, LCD, flat panel, plasma, projector, combinations thereof or any other now known or later developed display. Using a graphics processing unit or other hardware or software, the display 14 generates black and white or color pixels in a Cartesian or other coordinate format for presenting a graphical user interface.

The display 14 is operable to display a unified graphical user interface 18. The unified graphical user interface includes components associated with or linked to a plurality of different applications. Components include buttons, tabs, text, dialogs, values, icons, input boxes, pull-down menus, images, java scripts, animations, layouts or other now known or later developed graphical user interface component. In the example of FIG. 1, the unified graphical user interface 18 includes a layered tab structure 20 for displaying components associated with a selected tab. The components for a given tab may be responsive to only a single application or to multiple applications. The components for each of the various tabs are provided as part of the unified graphical user interface, such as being integrated in a common look and feel. Menu structures, such as associated with file, editing, viewing, inserting, formatting, tools, help, tables or other structures are provided at 22. A single menu structure with multiple options or a single option is provided in one embodiment of the unified graphical user interface. The menu components of the various applications are integrated as different selections within the same menu structure or sharing common selections. A single window 24 for use in a Windows operating system is provided for the unified graphical user interface. Additional windows may be provided, such as associated with dialogues based on selections or other activities within the unified graphical user interface.

The user input device 16 is a keyboard, mouse, trackball, touch pad, capacitive sensor, pedal, knob, button, slider, touch screen, infra red receiver, radio frequency receiver, combinations thereof or other now known or later developed input device. The input device 16 may include permanently coded or programmable inputs. For example, an LCD or other display is associated with the input device for indicating a current function for a given key.

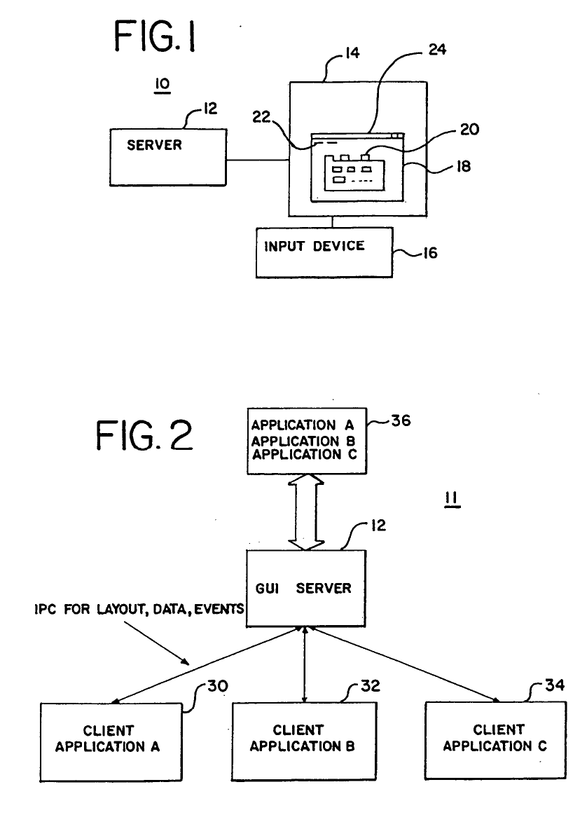

FIG. 2 shows another embodiment of the system 11 for coordinating graphics and/or input. The system 11 shown in FIG. 2 represents processes or programs for implementing the various components in the hardware described in FIG. 1. The system 11 includes the server 12, a plurality of applications 30, 32, 34 and an integrated graphical user interface 36. Additional, different or fewer components may be provided.

Each of the applications 30, 32, 34 is run on a same or different processor or processors. Each of the applications 30, 32, 34 is from a same or different source. For example, each of the applications is from a different manufacturer or company. The applications 30, 32, 34 are stand alone programs for performing a particular process. Each application may perform a same or different process. For example, one application 30 is associated with medical imaging or acquisition and display of medical imaging data. The medical imaging application includes various options for configuring, controlling, operating on or displaying ultrasound, x-ray, positron omission, magnetic residents or computed tomography images. Another application 32 is associated with further uses of the acquired data, such as generating three dimensional or real time three dimensional (4D) images based on the acquired data. The three dimensional rendering application includes controls, configurations, selections and algorithms for generating cut-planes, three dimensional images, or other information at specific rotations, viewing angles, shaving conditions, or other rendering options. Yet another application 34 is associated with a calculation package for determining volume flow, heart rate, strain or other values based on acquired imaging data. As another example, one application 30 is an e-mail application, another application 32 is a word processing application, and yet another application 34 is a spread sheet or presentation application. Different, additional or fewer applications may be provided in any of various environments.

Each of the applications 30, 32, 34 is operable to generate user interface data. For example, each of the applications 30, 32, 34 generates programming calls for graphical user interface displays of layout, data, events, event response behavior, combinations thereof or other graphical user interface components. The generated user interface data without the server 12 would normally require the generation of a dedicated graphical user interface for each application. The programming calls for data used for generating the graphical user interface is communicated with the inter-process communications. Various inter-process communications may be used, such as TCP/IP, system queue structures or other now known or later developed communications.

The interface data may be routed from the applications 30, 32, 34 to the server 12 or from the server 12 to the applications 30, 32, 34. For example, an event notification is routed from the server 12 indicating an adjustment of a value, input of data, selection, activation of a button or other user input appropriate for a given application 30, 32, 34. The application 30, 32, 34 generates corresponding interface data, such as a programming call to alter a display value based on the selection or adjustment.

The graphical user interface server 12 is a separate application for running or implementing a unified graphical user interface 36. The graphical user interface server 12 is implemented as a stand alone program or as part of an operating system. The server 12 is responsive to a plurality of client programs, such as the applications 30, 32, 34. In one embodiment, the server 12 operates the unified graphical user interface for all applications running in the system 10, but may implement the unified graphical user interface only for a subset of the applications 30, 32, 34. The server 12 receives the programming calls, HTML content, data, controls, components or other information passed on as interface data associated with the display or operation of a graphical user interface. For example, the server 12 receives inter-process communications specifying a layout, data, events or combinations thereof associated with each of a plurality of applications 30, 32, 34.

The server 12 is operable to integrate the user interface data from multiple applications into the unified graphical user interface 36. The unified graphical user interface 36 is, at least partly, displayed on the display 14. The unified graphical user interface 36 may additionally include input components, such as event triggers, associated with the input device 16. The unified graphical user interface 36 is generated by integration of the inter-process communications from the different applications 30, 32, 34 into a common layout, data display and/or event notification. If the server 12 has only a single client application 30, then the unified graphical user interface 36 may be rendered so as to be indistinguishable or the same as the applications standard graphical user interface, including multiple windows, dialogues, text boxes or other components.

Where multiple client applications 30, 32, 34 are operating at a same time, the server 12 integrates the graphic user interface information of the multiple clients. Each client application 30, 32, 34 logged onto, registered with or otherwise using the server 12 provides the interface data for implementing a respective graphical user interface. The server 12 uses rules and logic to integrate applications 30, 32, 34 so as to provide the unified graphical user interface 36. The rules of the server 12 are implemented using XML, parsing codes, HTML or other structures. The server 12 is configured to coordinate interactions and provide smooth work flow based upon desired policy or interaction between applications 30, 32, 34. For example, the user is guided from a portion of one application user interface components to a portion of another applications user interface components with all the appropriate graphical user interface components presented to the user in an appropriate order, including decision or branching logic, across the involved applications 30, 32, 34. The work flow is presented without the user having to know that different applications are being activated or run for implementing different processes. For example, a user activates an application for acquiring data associated with a volume using an imaging application. The user then selects three dimensional imaging, activating graphical user interfaces components associated with a different rendering application. A configuration policy or rule set of the server 12 implements or coordinates the various user activities. The server 12 provides a command set, such as an application programming interface for interaction with the applications 30, 32 and 34 with the unified graphical user interface 36. For example, the application programming interface of the server 12 links to a library of the operating system for implementing graphical user interfaces components. Where one or more of the applications 30, 32, 34 controls fine grained or detailed aspects of the user interface, the server 12 may render the graphical user interface components of the application 30, 32, 34 in a same or different manner.

The rules and logic dictate any desired features, such as the use of a single window, where to display different types of components (e.g. displaying an image in a center with associated data on the left, selectable buttons or other user controls on the right, menu or configuration structures on the top, and data processing adjustments across the bottom). As another example, components of user interfaces associated with each of the different applications are displayed in a pre-determined region of a same unified graphical user interface 36 such as shown in FIG. 4. The unified graphical user interface 36 is generated such that the multiple applications 30, 32, 34 appear to be a single application associated with different or related processes. Different applications are used to form parts of the same screen or overall graphical user interface. Similar or different color structures may be provided. The layout is generally the same for the same type of components. In alternative embodiments, the unified graphical user interface 36 distinguishes between the various applications while being provided as part of the unified structure, such as shown in FIG. 4. The distinction may include any of different sizes, shapes, colors, layouts, content or other alterations.

The server 12 is operable to generate any now known or later developed graphical user interface component for any of the applications 30, 32, 34. The components may be organized to appear on a same level or different levels within the user interface. For example, the unified graphical user interface 36 includes a plurality of tabs where components of one application 30 are provided on one tab and components of a different application 32 are provided under a different tab or dialog. Alternatively, components from a plurality of applications 30, 32 are provided in different positions of a same tab, window, dialog or display.

The given components for an application 30, 32, 34 displayed at a given time may alter as a function of time. For example, components associated with one application 32 have a subset displayed at one time. Due to a selection of a component associated with the same or a different application, further components may be added for display or removed from the display as appropriate. The components may be the same while data associated with the component is altered as a function of time. The applications 30, 32, 34 dynamically interact with linked or assigned graphical user interface components of the unified graphical user interface 36. State or data values, registering for events or other graphical user interface functions are implemented through selection or interactions with specifically linked graphical user interface components. For example, the user selects a button for indicating a type of imaging. The selection is communicated to the appropriate application 30. The application 30 then generates further graphical user interface programming calls or other information for altering the unified graphical user interface structure for additional selections, data displays, images or other information based on the selection of the type of imaging.

The server 12 is operable to operate the user input device 16 as a function of the unified graphical user interface. For example, the server 12 interacts with the input device 16 for identifying user input associated with a cursor on the screen or input associated with knobs, buttons or other input components of the input device 16. In one embodiment, the server 12 may override programming calls or other data associated with an application. The applications 30, 32, 34 are removed from or do not receive data about how input was generated. As a result, an input may be moved from an expected screen input using a cursor to an input on a keyboard. Versatility may be provided by programming the server 12 rather than re-programming any given application. For example, a legacy application 30 outputs a programming call for a displayed slider on the screen. A slider allows a user selection with a cursor of various positions along a continuum. For providing a more uniform look and feel, the server 12 may display a rotatable knob or other type of graphical user interface component different than the application instructed graphical user interface component. The server 12 then converts input adjustments into the format expected by the application. Alternatively, the different types of components are generated for the different applications.

The server 12 is operable with legacy applications, such as applications programmed to provide their own graphical user interfaces. For legacy applications, the server 12 receives commands for building the applications graphical user interface. The server 12 provides commands to modify the unified graphical user interface, including adding and removing items, and changing the state or properties of items. The server 12 also provides commands for updating the graphical user interface data and for notifying the clients or applications when events occur associated with the graphical user interface. The received graphical user interface commands may be used to display the same component or a modified component. Alternatively or additionally, the server 12 is operable with applications programmed to interact with a separate application for implementing the unified graphical user interface 36. Alternatively, an application 30 generates data to be used for the graphical user interface without indicating a particular type of component, display location, display size, layout, event or other characteristic. The server 12 receives the data. Based on the type of data received, the server 12 provides the instructions for the specific graphical user interface component associated with the data.

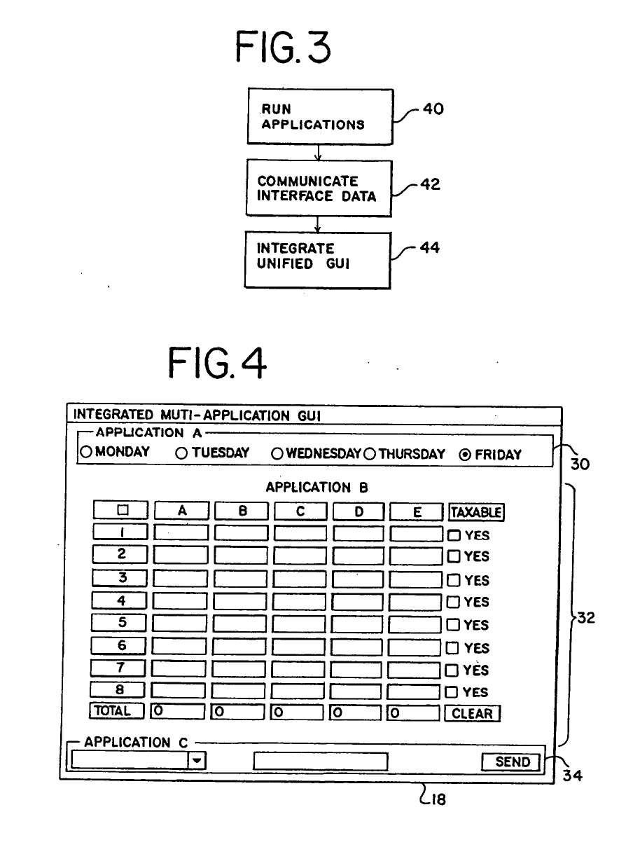

FIG. 3 shows one embodiment of a method for coordinating graphics and/or input with applications. The method is implemented using the system 10 of FIG. 1 or 2, or a different system. Additional, different or fewer acts may be provided than shown in FIG. 3. Since FIG. 2 represents a system based on interactions through software, the processes described above with respect to FIG. 2 may be implemented in the method of FIG. 3. Alternatively, different processes are used.

In act 40, a plurality of applications is run. Applications may be run in any of various states, such as an active state, a queued state, a sleep state or a stand-by state. The applications are run on a same system, such as a same embedded system. For example, the applications are all run on a medical diagnostic ultrasound imaging system. One or more of the applications may be a medical diagnostic imaging application, such as associated with configuring and operating imaging hardware. Alternatively, the applications are run on different systems or a general or open system, such as a personal computer or work station.

The applications are from the same or different sources. Sources include manufacturers, programmers, companies, projects or other differentiators of applications. The applications are stand alone programs that may rely on no or some interaction with other applications for operation. For example, the applications rely on an operating system for performing operations. As another example, an application relies on data from a different application. In one example embodiment, one application is an imaging application for configuring and operating an imaging system. Another application is for implementing a specific process associated with acquired image data, such as a three dimensional rendering application.

The applications generate programming calls based on implemented processes. One or more of the programming calls may be associated with graphical user interface information. For example, a programming call associated with obtaining a specific graphical user interface component from a library of components for display, a layout, a data, event or other graphical user interface information is identified in the programming call. Different programming calls are generated by different applications. The different programming calls may be for a same or different type of component.

In act 42, interface data, such as the programming calls, are communicated between the server or graphical user interface application and the other applications. For example, the server receives programming calls or other inter-process communications. The communications are provided over a database, wirelessly, through a memory, through a data bus, a direct connection, an indirect connection, or over a network. For example, a data bus or memory structure is used for providing programming calls to a processor within an embedded system. The same processor also implements one or more of the applications generating the programming calls.

In one embodiment, the communicated interface data corresponds to unspecified graphical user interface requests, such as data for display, a user controllable function, a request for input or other information. The information is used for generating a corresponding graphical user interface component. In other embodiments, a specific graphical user interface component request is communicated to the server from one or more of the applications. For example, inter-process communications specifying buttons, layouts, data, events or input components are communicated from the application to the server.

Rather than generating separate graphical user interfaces in response to programming calls or other communications, the server integrates the user interface data in a unified graphical user interface in act 44. Display and input devices are configured to provide the uniform graphical user interface. For example, the input devices and associated display on a medical diagnostic system are configured as a function of the unified graphical user interface. The separate programming calls from the applications for different graphical user interfaces are routed through the inter-processing communications to a set of rules for integrating the graphical user interfaces into the unified graphical user interface. Using the application programming interface of the server, the programming calls or other graphical user interface data is diverted or used by the server to generate the unified graphical user interface. The server calls a library of rules and associated user interface components for establishing the unified graphical user interface.

Components of the unified graphical user interface are linked to the specific applications. For an example shown in FIG. 4, radio buttons for selectable days of the week are linked to the application 30. A table with various inputs and selectable buttons is linked to a different application 32. A pull-down menu, a text entry box, and a selectable button are linked to the other application 34. Events occurring associated with the radio buttons are routed to the corresponding application 30. Similarly, applications 32 and 34 issue commands to add their respective content, update graphical user interface values and register for events. Each application 30, 32, 34 submits commands to the server to interact with the associated controls implemented by components without the user needing to be aware that separate applications are involved. While shown as separate regions by application on the unified graphical user interface 18, the graphical user interface components may be intermingled. For example, the button A and B of the table are linked to application 30 while button C and D are linked to application 34. The same type of graphical user interface components may be grouped together in a pre-determined, random or desired pattern or location.

Data or events related to a component may additionally or alternatively be broadcast to two or more applications 30, 32, 34. For example, selecting a button may result in sending requests to many applications 30, 32, 34 with the server 12 providing logic for combining the results received. The server 12 is able to re-link or re-route events dynamically. For example, a set of knobs on the graphical user interface or on another input device (e.g. the ultrasound console) may be dynamically re-mapped or re-linked to whichever rendering application 30, 32, 34 is currently active. If the images or other data can be processed by more than one application 30, 32, 34, the user may not even know that a different application is servicing the knob events at different times. Also, this re-mapping or re-linking is performed independently of the client applications 30, 32, 34, which in many cases will not need to provide specific support for, or have knowledge of, such changes.

The unified graphical user interface 18 shown in FIG. 4 shows separate applications sections in a single layer with a same look and feel. In alternative embodiments, the components are identified as separate processes. In yet other embodiments, separate applications are not identified. In any of these embodiments, the graphical user interface 18 has a common look and feel.

The linked graphical user interface components may be the same or different than components requested by a given application. For example, an application provides interface data associated with a first type of user interface component. The graphical user interface is generated with a different type of component linked with the application and the specific component requests or interface data. Since the different type of graphical user interface component is provided on the unified graphical user interface 18, the application requested component is not displayed. The server generates the linked different type of component for performing the same function. The server overrides the format, layout, data, event, type of component, combinations thereof or other information requested or typically controlled by the application.

The unified graphical user interface may be generated such that the different applications appear to be a single application. The various graphical user interface components associated with the plurality of applications may be displayed in a tab, dialog or single level graphical user interface. The mix of components associated with the different applications, such as the type, placement, size, selected groups of components or other characteristics may be altered as a function of time. For example, as various inputs are provided on the graphical user interface, different types of components associated with different functions and one or more of the applications are altered, such as being emphasized, removed, replaced or added.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. A method for coordinating graphical and/or input, the method comprising:
(a) running first and second applications corresponding to first and second user interface data, respectively;
(b) communicating the first and second user interface data between a server and the first and second applications; and
(c) integrating the first and second user interface data in a unified graphical user interface.

2. The method of claim 1 wherein (a) comprises running a three-dimensional rendering application and an imaging application.

3. The method of claim 1 wherein (a) comprises generating programming calls with each of the first and second applications for respective, separate first and second graphical user interfaces, and wherein (c) comprises generating the unified graphical user interface as a function of the programming calls for the separate first and second graphical user interfaces.

4. The method of claim 1 wherein (b) comprises generating interprocess communications specifying first and second graphical user interfaces for the first and second applications, respectively, and wherein (c) comprises routing the interprocess communications to a set of rules for integrating the first and second graphical user interfaces into the unified graphical user interface.

5. The method of claim 1 wherein (c) comprises generating the unified graphical user interface such that the first and second applications appear to be a single application.

6. The method of claim 1 wherein (a) comprises running on a same embedded system, wherein (b) comprises communicating within the embedded system, the server comprising a processor of the embedded system, and wherein (c) comprises configuring a display and an input device as the unified graphical user interface.

7. The method of claim 6 wherein (a) comprises running on a medical diagnostic ultrasound imaging system.

8. The method of claim 1 wherein (b) comprises communicating graphical user interface components to the server from each of the first and second applications.

9. The method of claim 8 wherein (c) comprises generating the unified graphical user interface with an application programming interface, graphical user interface components of the unified graphical user interface linked with specific ones of the graphical user interface components communicated to the server from each of the first and second application.

10. The method of claim 1 wherein (a) comprises running the first application from a first source and the second application from a second source, the first source different than the second source.

11. The method of claim 1 wherein (c) comprises generating graphical user interface components of the unified graphical user interface for the first application in a different tab or dialog than for the second application.

12. The method of claim 1 wherein (c) comprises generating graphical user interface components of the unified graphical user interface in different positions of a same window or dialog.

13. The method of claim 1 wherein (c) comprises altering a mix of components associated with the first and second applications in the unified graphical user interface as a function of time.

14. The method of claim 8 wherein a first graphical user interface component from the first application is of a first type, and wherein (c) comprises:
(c1) generating a unified graphical user interface component of a second type different than the first type; and
(c2) linking the unified graphical user interface component to the first graphical user interface component without displaying the first graphical user interface component as the first type.

15. A system for coordinating graphical and/or input, the system comprising:
a first application operable to generate first user interface data;
a second application operable to generate second user interface data;
a display;
a server operable to receive the first and second interface data and operable to integrate the first and second user interface data in a unified graphical user interface, at least partly, displayed on the display.

16. The system of claim 15 wherein the server comprises a processor operable to separately run the first and second applications.

17. The system of claim 15 further comprising:
a user input;
wherein the server is operable to operate the user input as a function of the unified graphical user interface.

18. The system of claim 15 wherein each of the first and second user interface data comprise interprocess communications specifying layout, data, events or combinations thereof, and wherein the server is operable to integrate the interprocess communications from both the first and second applications into a common layout, data display, and event notification.

19. The system of claim 15 wherein the server is operable to generate the unified graphical user interface such that the first and second applications appear to be a single application.

20. The system of claim 15 wherein the server comprises a medical diagnostic ultrasound imaging system, the first and second applications being run on the medical diagnostic ultrasound imaging system.

21. The system of claim 15 wherein the server is operable to generate graphical user interface components of the unified graphical user interface for the first application in a different tab or dialog than for the second application.

22. The system of claim 15 wherein the server is operable to generate graphical user interface components of the unified graphical user interface in different positions of a same window or dialog.

23. The system of claim 15 wherein the server is operable to alter a mix of components associated with the first and second applications in the unified graphical user interface as a function of time.

24. The system of claim 15 wherein the first user interface data corresponds to a first type of graphical user interface component, and wherein the server is operable to generate the unified graphical user interface with a second type of graphical user interface component different than the first type in response to the first user interface data.

25. A method for coordinating graphical and/or input in a medical diagnostic imaging system, the method comprising:
(a) running first and second applications associated with first and second user interface data, respectively, the first application being a medical diagnostic imaging application;
(b) communicating the first and second user interface data between a graphical user interface application and the at least first and second applications; and
(c) integrating the first and second user interface data in a unified graphical user interface on the medical diagnostic imaging system.
